(19) United States
(12) Patent Application Publication
(10) Pub. No.: US 2024/0016205 A1
(43) Pub. Date: Jan. 18, 2024

(54) HOOKAH INFUSER DEVICE

(71) Applicants: Darnell Becote, Baltimore, MD (US); Talia Tinkler, Catonsville, MD (US); Debra Becote, Baltimore, MD (US)

(72) Inventors: Darnell Becote, Baltimore, MD (US); Talia Tinkler, Catonsville, MD (US); Debra Becote, Baltimore, MD (US)

(21) Appl. No.: 17/937,565

(22) Filed: Oct. 3, 2022

Related U.S. Application Data
(60) Provisional application No. 63/368,287, filed on Jul. 13, 2022.

(51) Int. Cl. A24F 1/30; A23B 4/052

(52) U.S. Cl. CPC A24F 1/30; A23B 4/052; A23V 2002/00

(57) ABSTRACT

A hookah infuser device providing two pineapple or capsule-shaped vessels spaced apart by a rotatable chamber with a passageway that fluidly couples the two capsule-shaped vessels in a first direction. A conduit may fluidly connect an external elemental holder to the chamber in a second direction, transverse to the first direction, wherein the conduit intersects the passageway at an intersection point or nexus. The chamber may be selectively rotated so that the two pineapple or various shaped fruit or capsule-shaped vessels experience a centrifugal force that urges a fluid within one or both vessels flee from the center of the respective vessel into the passageway and to the nexus point, thereby infusing an essence, such as vapors, of an element disposed in the external elemental holder.

### CROSS-REFERENCE TO RELATED APPLICATION

This application claims the benefit of priority of U.S. provisional application No. 63/368,287, filed Jul. 13, 2022, the contents of which are herein incorporated by reference.

### BACKGROUND OF THE INVENTION

The present invention relates to hookah infusers and, more particularly, an infuser device having two opposing capsule-shaped compartments or vessels separated by a rotating body fluidly coupled to a bowl portion. The capsule or ‘caplet’ shape may also be the shape of a pineapple or various other fruit shapes. The rotating body rotates about an axis allowing a fluid to move between the two vessels via a chamber in the rotating body. A conduit may be fluidly coupled to the chamber, thereby the arrangement of these components enables the hookah Infuser device to operate as a smoke infuser device that can also be used as a food smoker, a drink infuser, dab device and/or a hookah.

### SUMMARY OF THE INVENTION

In one aspect of the present invention, a infuser device includes two vessels spaced apart by a rotatable chamber with a passageway that fluidly couples the two vessels in a first direction; a conduit may fluidly connect an external elemental holder to the chamber in a second direction, transverse to the first direction, wherein the conduit intersects the passageway at a nexus; and wherein the chamber is selectively rotatable so that the two vessels experience a centrifugal force urges a vessel fluid within one or both of the vessels to flee from a center thereof and into the passageway and to the nexus, whereby said vessel fluid physically interacts with a fluid in the conduit.

In another aspect of the present invention, the infuser device includes wherein each vessel is capsule-shaped and coupled to the chamber by way of threading or magnetic force, wherein the conduit comprises an internal conduit defining in part the intersection point and a fluidly coupled external conduit.

In yet another aspect of the present invention, a method of infusing a first fluid with a second fluid, the method includes urging the first fluid into a chamber by way of an external conduit; intersecting the first fluid with a second fluid at a nexus within the chamber, wherein the second fluid flows between two spaced apart vessels; and selectively rotating the chamber so that the two vessels experience a centrifugal force urging the second fluid from one or both of the two vessels into the nexus, where wherein the first and second fluids physically interacts.

In one aspect of the present invention, a hookah infuser device includes two vessels spaced apart by a rotatable chamber with a passageway that fluidly couples the two vessels in a first direction; a conduit may fluidly connect an external elemental holder to the chamber in a second direction, transverse to the first direction, wherein the conduit intersects the passageway at a nexus; and wherein the chamber is selectively rotatable so that the two vessels experience a centrifugal force urges a vessel fluid within one or both of the vessels to flee from a center thereof and into the passageway and to the nexus, whereby said vessel fluid physically interacts with a fluid in the conduit.

In another aspect of the present invention, the pineapple Infuser device includes wherein each vessel is pineapple capsule-shaped or various fruit or capsule shapes and may be coupled to the chamber by way of threading or magnetic force, wherein the conduit comprises an internal conduit defining in part the intersection point and a fluidly coupled external conduit.

In yet another aspect of the present invention, a method of infusing a first fluid with a second fluid, the method includes urging the first fluid into a chamber by way of an external conduit; intersecting the first fluid with a second fluid at a nexus within the chamber, wherein the second fluid flows between two spaced apart vessels; and selectively rotating the chamber so that the two vessels experience a centrifugal force urging the second fluid from one or both of the two vessels into the nexus, where wherein the first and second fluids physically interacts.

These and other features, aspects and advantages of the present invention will become better understood with reference to the following drawings, description, and claims.

### BRIEF DESCRIPTION OF THE DRAWINGS

FIG. 1 is a perspective view of an exemplary embodiment of the present invention, shown use.

FIG. 2 is a perspective view of an exemplary embodiment of the present invention.

FIG. 3 is a left-side elevation views of an exemplary embodiment of the present invention.

FIG. 4 is a left-side elevation views of an exemplary embodiment of the present invention.

FIG. 5 is an exploded perspective view of an exemplary embodiment of the present invention.

FIG. 6 is a partial section view of an exemplary embodiment of the present invention, taken along line 6-6 from FIG. 1.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides an Hookah infuser device dimensioned and adapted to operate as a smoke infuser device that can be used as a food smoker, a drink infuser, dab device and/or a hookah. The infuser device provides two Pineapple shaped or various fruit or capsule-shaped vessels spaced apart by a rotatable chamber with a passageway that fluidly couples the two Pineapple capsule-shaped vessels in a first direction. A conduit may fluidly connect an external elemental holder to the chamber in a second direction, transverse to the first direction, wherein the conduit intersects the passageway at an intersection point or nexus. The chamber may be selectively rotated so that the two Pineapples or fruit shaped or capsule-shaped vessels experience a centrifugal force that urges a fluid within one or both of the vessels flee from the center of the respective vessel into the passageway and to the nexus point, thereby infusing an essence, such as vapors, of an element disposed in the external elemental holder.

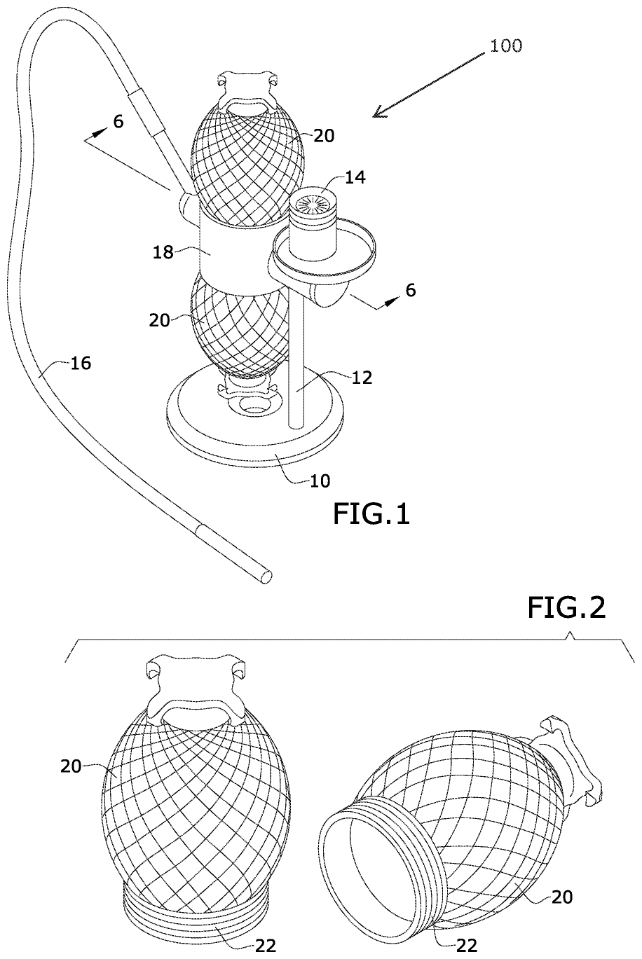

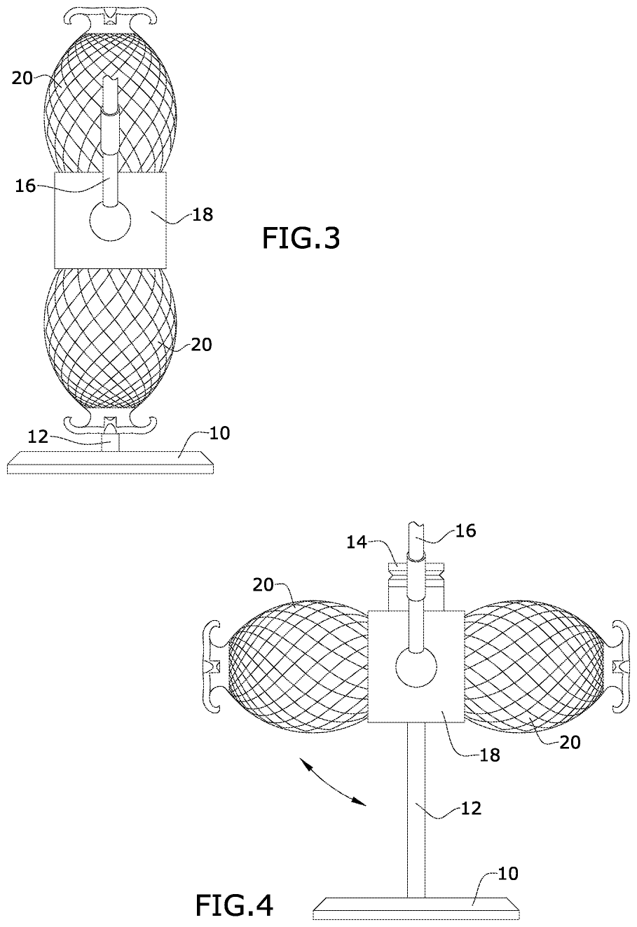

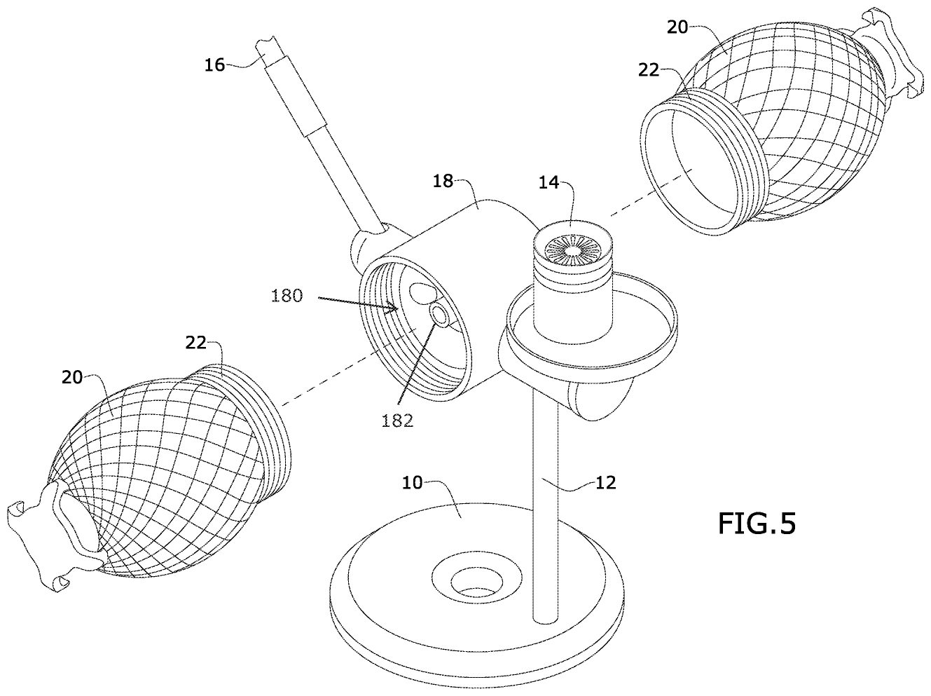

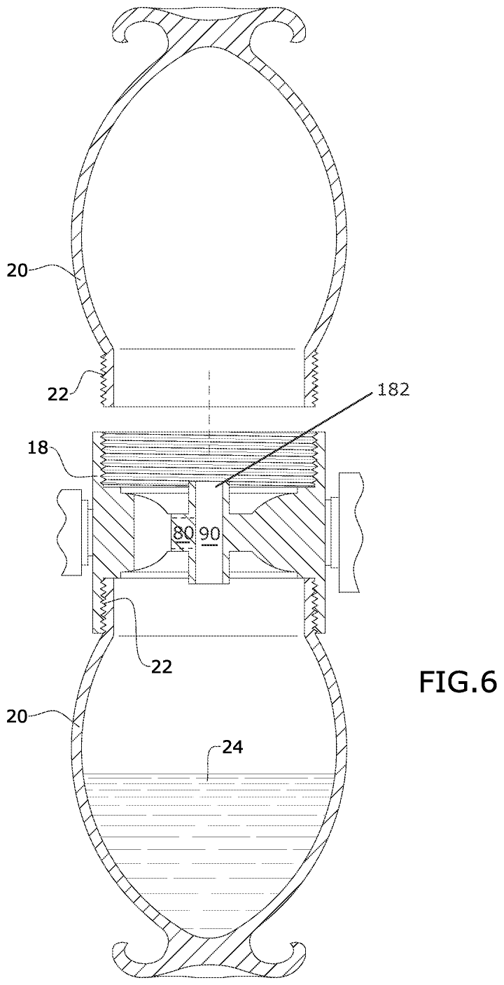

Referring now to FIGS. 1 through 6, the present invention may include an hookah infuser device 100. The hookah infuser device 100 may have a base portion 10 dimensioned and adapted to support the hookah infuser device 100 on a supporting surface. A stand portion 12 extends upward from the base portions 10/supporting surface for supporting the hookah infuser device 100 or portions thereof in an upright position. The stand portion 12 supports an elemental holder portion 14 adapted to retain elements, such as burning matter or objects such as citrus fruits that have an essence.

A rotating body 18 may be operatively associated with the elemental holder portion 14. The rotating body 18 may define a chamber 180 fluidly coupled to the elemental holder portion 14 by way of an internal conduit 80. The conduit 80 enters the chamber in a first direction. The chamber 180 may fluidly connected opposing vessels 20 by way of a passageway 182 within the chamber 180. The passageway 182 may extend in a second direction, transverse relative to the first direction. The passageway 182 and the internal conduit fluidly couple at an intersection point 90.

Two vessels 20, one connected on each of a first side and a second side of the rotating body 20, are contemplated by the present invention. Each vessel 20 defines a compartment. Each vessel 20 may be made from borosilicate glass and in the shape of a pineapple or various other fruit shape capsules, through the present invention contemplates other materials and shapes for the vessels 20. The above components may snap together magnetically or through other structures such as threading 22 or the like.

An external conduit 16 may be fluidly coupled to the rotating body 1, specifically the internal conduit 80 so that changes of air pressure on the external conduit 16 are felt in the internal conduit 80. A fluid 24, such as water, may be contained in one or both vessels 20 so that when the rotating body 18 is rotated, as illustrated in FIG. 4, the fluid 24 moves between vessels 20 by away of the passageway 182, thereby transferring heat to and infusing the air and/or smoke being drawn from the bowl portion 14 by way of the conduit 16.

In some embodiments, the chamber 180/rotating body 18 may be selectively rotated so that the two fruit or capsule-shaped vessels 20 experience a centrifugal force that urges a fluid within each vessel 20 flee from the center of the respective vessel 20 into the passageway and to the intersection point 90. At this nexus, the fluid 24 physically interacts with, and thereby hereby infuses an essence, such as vapors, of an element disposed in the elemental holder portion 14, when an air pressure differential exists between the internal conduit 80 coupled to the elemental holder portion 14 and the external conduit 16, such as from suction.

Accordingly, the infuser device 100 can be used as a food smoker, drink infuser, and/or a hookah or dab device. A dab may come in many forms, but almost all are produced using butane oil to concentrate the active ingredients of a smokeable plant.

Specifically, a method of using the present invention may include the following. The infuser device 100 disclosed above may be provided. By way of the rotating body 18, the two opposing vessels 20 may rotate 360-degrees about an axis of rotation orthogonal to the stand portion 12. The rotation does not inhibit smoke generated via the bowl/elemental holder portion 14 from being drawn into the chamber 180 or beyond (into the conduit 16), and, while in the chamber 180, infusing drinks or food. A user could also remove the conduit 16 to use as a standard smoke port. The present invention may thusly be used for food preparation, drink preparation, dab device and/or pipe smoking.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A hookah infuser device comprising:
two vessels spaced apart by a rotatable chamber with a passageway that fluidly couples the two vessels in a first direction;
a conduit may fluidly connect an external elemental holder to the chamber in a second direction, transverse to the first direction, wherein the conduit intersects the passageway at a nexus; and
wherein the chamber is selectively rotatable so that the two vessels experience a centrifugal force urges a vessel fluid within one or both of the vessels to flee from a center thereof and into the passageway and to the nexus, whereby said vessel fluid physically interacts with a fluid in the conduit.

2. The hookah infuser device of claim 1, wherein each vessel is capsule-shaped.

3. The hookah infuser device of claim 1, wherein each vessel is shaped like a pineapple.

4. The hookah infuser device of claim 1, wherein each vessel is coupled to the chamber by way of threading.

5. The hookah infuser device of claim 1, wherein each vessel is coupled to the chamber by way of magnetic force.

6. The hookah infuser device of claim 1, wherein the conduit comprises an internal conduit defining in part the intersection point and a fluidly coupled external conduit.

7. A method of infusing a first fluid with a second fluid, the method comprising:
urging the first fluid into a chamber by way of an external conduit;
intersecting the first fluid with a second fluid at a nexus within the chamber, wherein the second fluid flows between two spaced apart vessels; and
selectively rotating the chamber so that the two vessels experience a centrifugal force urging the second fluid from one or both of the two vessels into the nexus, where wherein the first and second fluids physically interacts.
